(19) United States
(12) Patent Application Publication
(10) Pub. No.: US 2022/0366605 A1
(43) Pub. Date: Nov. 17, 2022

(54) ACCURATE GEOLOCATION IN REMOTE-SENSING IMAGING

(71) Applicant: SEETREE SYSTEMS LTD., Tel Aviv (IL)

(72) Inventors: Ori SHACHAR, Nes Harim (IL); Guy MORGENSTERN, Mevaseret Tzion (IL)

(21) Appl. No.: 17/741,826

(22) Filed: May 11, 2022

Related U.S. Application Data
(60) Provisional application No. 63/187,986, filed on May 13, 2021.

(51) Int. Cl. G06T 7/80; G06T 7/11

(52) U.S. Cl. CPC G06T 7/80; G06T 7/11; G06T 2207/30188; G06T 2207/30252

(57) ABSTRACT

A method comprising: receiving an image of an agricultural area-of-interest (AOI) acquired by a remote-sensing platform; performing an initial rectification to correct geometric distortions in the image; assigning initial geographic coordinates within a reference coordinate system to each data point in the image, based, at least in part, on location data recorded by the remote-sensing platform; performing object detection in the image, to detect at least some of the plants in the image; selecting a specified subset of the detected plants; calculating a transformation between the image and the reference coordinate system based on a comparison, with respect to each of the plants in the specified subset, between (i) the initial geographic coordinates assigned to the plant, and (ii) corresponding ground-truth geographic coordinates obtained with respect the plant; and performing an alignment between the image and the reference coordinate system based, at least in part, on the calculated transformation.

### CROSS-REFERENCE TO RELATED APPLICATIONS

This application claims priority from U.S. Application Ser. No. 63/187,986, filed May 13, 2021, the content of which is hereby incorporated in its entirety by reference.

### BACKGROUND

This invention relates to the field of computer image processing.

Precision agriculture is revolutionizing farming practices, by leveraging crop monitoring to optimize production processes and calibrating inputs and operations, thereby improving yields and reducing costs. At its core, precision farming uses high-resolution data with respect to agricultural areas, to allow for variability and differentiation in the treatments and inputs applied to crops at the individual plant level.

An effective management of precision agriculture requires reliable crop monitoring procedures. Remote sensing represents a powerful technology for this task, providing huge amount of data, without any physical contact, from which valuable information can be derived, such as plant size and dimensions, radiometric indices, health indicators, water stresses, and the like.

However, accurately and precisely localizing or georeferencing ground objects, such as plants and trees, detected through remote or aerial sensing means, remains a challenging task. Specifically, because image data is obtained using remote means (such as an airborne platform), a challenge exists in aligning those image data to a reference coordinate system. Several factors negatively affect the accuracy of geolocated or georeferenced remote or aerial imagery, including the limited accuracy of Global Navigation Satellite Systems (GNSSs), aerial camera angle variations, aerial platform speed and altitude variations, etc. These can combine to introduce distortions and inaccuracies in the georeferenced data, and in turn, hinder the efficacy of precision agriculture applications.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive an image of an agricultural area-of-interest (AOI), wherein the AOI comprises a plurality of rows of plants ordered in a known pattern, and wherein the image is obtained during an image acquisition session by a remote-sensing platform, perform an initial rectification with respect to the image, to correct geometric distortions in the image, assign initial geographic coordinates within a reference coordinate system to each data point in the image, based, at least in part, on location data recorded by the remote-sensing platform during the image acquisition session, perform object detection in the image, to detect at least some of the plants in the image, select a specified subset of the detected plants, calculate a transformation between the image and the reference coordinate system based on a comparison, with respect to each of the plants in the specified subset, between (i) the initial geographic coordinates assigned to the plant, and (ii) corresponding ground-truth geographic coordinates obtained with respect the plant, and perform an alignment between the image and the reference coordinate system based, at least in part, on the calculated transformation.

There is also provided, in an embodiment, a computer-implemented method comprising: receiving an image of an agricultural area-of-interest (AOI), wherein the AOI comprises a plurality of rows of plants ordered in a known pattern, and wherein the image is obtained during an image acquisition session by a remote-sensing platform; performing an initial rectification with respect to the image, to correct geometric distortions in the image; assigning initial geographic coordinates within a reference coordinate system to each data point in the image, based, at least in part, on location data recorded by the remote-sensing platform during the image acquisition session; performing object detection in the image, to detect at least some of the plants in the image; selecting a specified subset of the detected plants; calculating a transformation between the image and the reference coordinate system based on a comparison, with respect to each of the plants in the specified subset, between (i) the initial geographic coordinates assigned to the plant, and (ii) corresponding ground-truth geographic coordinates obtained with respect the plant; and performing an alignment between the image and the reference coordinate system based, at least in part, on the calculated transformation.

There is further provided, in an embodiment, a computer program product comprising a non-transitory computer-readable storage medium having program instructions embodied therewith, the program instructions executable by at least one hardware processor to: receive an image of an agricultural area-of-interest (AOI), wherein the AOI comprises a plurality of rows of plants ordered in a known pattern, and wherein the image is obtained during an image acquisition session by a remote-sensing platform; perform an initial rectification with respect to the image, to correct geometric distortions in the image; assign initial geographic coordinates within a reference coordinate system to each data point in the image, based, at least in part, on location data recorded by the remote-sensing platform during the image acquisition session; perform object detection in the image, to detect at least some of the plants in the image; select a specified subset of the detected plants; calculate a transformation between the image and the reference coordinate system based on a comparison, with respect to each of the plants in the specified subset, between (i) the initial geographic coordinates assigned to the plant, and (ii) corresponding ground-truth geographic coordinates obtained with respect the plant; and perform an alignment between the image and the reference coordinate system based, at least in part, on the calculated transformation.

In some embodiments, the calculating comprises determining, with respect to each of the plants in the specified subset, an offset vector representing an extent and direction of a location offset between (i) the geographic coordinates assigned to the plant, and (ii) ground-truth geographic coordinates obtained with respect to the plant.

In some embodiments, the calculating further comprises calculating a global transformation matrix, based, at least in part, on all of the calculated offset vectors.

In some embodiments, the remote-sensing platform comprises one of: an unmanned aerial vehicle (UAV), a manned aerial vehicle, a helicopter, an airplane, and a satellite.

In some embodiments, the image is a mosaicked image generated from a set of at least partially overlapping images of the AOI.

In some embodiments, the program instructions are further executable to generate, and the method further comprises generating, a three-dimensional (3D) model of the AOI using the set of at least partially overlapping images.

In some embodiments, the 3D model is one of: a point cloud, a digital terrain model (DTM), and a digital surface model (DSM).

In some embodiments, the AOI is one of: an agricultural field, a farm, a forest, an orchard, a grove, and a wood.

In some embodiments, the location data recorded by the remote-sensing platform are based on at least one of: GPS coordinates, and inertial measurement unit (IMU) coordinates.

In some embodiments, the specified subset of plants comprises at least one plant located at an outside corner of the AOI.

In some embodiments, the specified subset of plants comprises at least one plant located at an outer row or an outer edge of the AOI.

In some embodiments, the specified subset of plants comprises at least one plant located within an interior of the AOI.

In addition to the exemplary aspects and embodiments described above, further aspects and embodiments will become apparent by reference to the figures and by study of the following detailed description.

### BRIEF DESCRIPTION OF THE FIGURES

The present invention will be understood and appreciated more comprehensively from the following detailed description taken in conjunction with the appended drawings in which:

FIG. 1 shows a schematic illustration of an exemplary system 100, for accurate georeferencing and geo-rectification of remotely-sensed image data (e.g., aerial images) of an area-of-interest (AOI), according to some embodiments of the present invention, according to some embodiments of the present invention;

FIG. 2 is a flowchart of the functional steps in a method for accurate georeferencing and geo-rectification of remotely-sensed image data (e.g., aerial images) of an area-of-interest (AOI), according to some embodiments of the present invention;

FIG. 3A shows an image of an AOI comprising a plurality of rows of crops in a generally structured pattern, according to some embodiments of the present invention;

FIG. 3B shows exemplary input images covering an AOI shown in FIG. 3A, comprising a series of images which may be at least partially overlapping, according to some embodiments of the present invention;

FIG. 4A shows a mosaic image generated by stitching individual input images of an AOI, according to some embodiments of the present invention;

FIG. 4B shows the mosaic image after the process of plant detection and segmentation, according to some embodiments of the present invention;

FIGS. 5A-5C show alternative anchor points selection schemes, according to some embodiments of the present invention;

FIG. 6 schematically show a process for calculating an offset vector, according to some embodiments of the present invention; and

FIG. 7 shows a height adjustment parameter of a sprayer under various spraying plans for a row of trees of varying height, according to some embodiments of the present invention.

### DETAILED DESCRIPTION

Disclosed herein is a technique, embodied in a system, computer-implemented method, and computer program product, for accurate georeferencing and geo-rectification of remotely-sensed image data (e.g., aerial images) of an area-of-interest. In some embodiments, the present technique provides for accurate georeferencing and geo-rectification of remotely-sensed image data (e.g., aerial images) of an area-of-interest without the need for ground control points (GCP).

In some embodiments, the area-of-interest (AOI) is a ground scene, such as a cultivated agricultural area associated with the growing of crops, for example, a plot, an orchard, a grove, a vineyard, a field, and the like. In some embodiments, the objects are cultivated plants within the AOI, e.g., trees, vines, shrubs, and/or any other type of plants.

Embodiments of the present invention provide systems and methods for accurately and precisely geolocating or georeferencing agricultural crops in remote-sensing means.

A common way to achieve image data and precise geolocation of crops is through the use of ground-based crop mapping methods, which combine imaging sensors (such as cameras, 3D laser scanners) and location-based sensors (such as GPS sensors) mounted to a vehicle that roves on the ground to collect data row-by-row. As can be readily understood, ground-based crop mapping is a costly and labor-intensive process, which can be prohibitively expensive in some applications, especially in the case of modern large-scale farming.

In contrast, to ground-based methods, remote or aerial platforms, such as unmanned aerial vehicles (UAV)-based remote sensing systems, offer great possibilities to acquire field data over large areas in an efficient and cost-effective way. Compared to ground-based methods, UAVs can cover large areas in a shorter amount of time and at a lower cost. The ability of UAVs to fly at low altitudes results in high spatial-resolution images of the crops, which significantly improves the performance of the monitoring systems. Furthermore, UAV-based monitoring modalities have high temporal resolution, because they can be used with increased frequency and at the user's will. This enhances the flexibility of the image acquisition process.

Data acquired from remote sensing imagery can enable growers to evaluate such plant parameters as height, width, mass, shape, volume, leaf density, trunk diameter, leaf color, fruit size, and the like. Based on this, growers are able to determine the overall health status of plants, detect diseases, assess water stress, predict fruit count, expected harvest date, and/or other similar information. Ultimately, these data can then be used to devise and implement plant- and/or site-specific farming operations, e.g., fertilization, pruning, spraying, and the like.

As used herein, ‘remote sensing’ may refer broadly to methods, techniques, and devices which make use of radiant energy acquired with respect to an area-of-interest, to extract information on ground features along large swath within a short period of time. Remote sensing techniques obtain data, e.g., image data, about a geographic region from a distance, typically from some type of an aerial platform. These remotely-sensed data, e.g., images, can be obtained using any low- or high-altitude data gathering modalities, including any form of aerial or satellite imaging modalities. Common remote sensing platforms include satellites, manned and unmanned aerial vehicles, balloons and helicopters. Common remote sensing devices include a variety of sensors such as optical, multi-spectral, hyperspectral, infrared, and radar sensors, installed on these platforms for remote sensing applications.

However, the ability to effectively manage precision agriculture using remote-sensing imagery requires accurate mapping and modeling of crops in the acquired images. In other words, in order to implement precision plant-specific operations based on the data acquired remotely, the growers must know the exact geographic location of each data point (pixel) in the image data. This, in turn, enables growers to determine the precise ground location of each plant in the imagery, and to assign a unique identifier to each such plant for ongoing treatment and monitoring purposes.

The process for precisely geolocating or georeferencing each data point in remote or aerial imagery within a defined reference coordinate system is commonly referred to as ‘geolocating’ or ‘georeferencing.’

Typically, in the context of remote imagery platforms, the imaging sensor may be on-board an UAV and is usually pointed vertically down toward the ground. Multiple overlapping images may be collected as the imaging sensor flies along a flight path. Thus, remotely-sensed data covering an agricultural area-of-interest may comprise a series or sequence of individual images, each covering a portion of the area, wherein adjacent images in the sequence may be at least partially overlapping, e.g., in the lateral and/or longitudinal dimensions.

However, images acquired from a remote imagery platform suffer from geometric distortions, which vary considerably with different factors, and each image acquisition system produces unique geometric distortions in its raw images. Geometric distortion comprises internal and external distortions. Internal distortions are caused by a sensor and include lens distortion, misalignment of detectors and variations of sampling rate. External distortions are caused by parameters other than the sensor, including variations of altitude and position of the platform, earth curvature, perspective, and geometry.

Thus, the ultimate accuracy of aerial images and mosaics generated from them is dependent on several variables, including, but not limited to:
Imaging device altitude above the ground and view angle and direction during image acquisition, including, e.g., the roll, pitch and/or yaw angles of every image in the sequence;
Imaging device internal orientation, e.g., the camera attitude and degree of optical image distortion, based on its calibration;
the density and distribution of ground control points (GCPs); and
the topographic complexity of the scene.

Thus, a geometric correction process must be applied to raw remote-sensing image data, to effectively use those images in a geographic information system (GIS) for any further analysis. The geometric correction process is normally referred to as image georectification. The rectified image has the same lack of distortion as a map of the area. In contrast with a simple aerial image of a field, a rectified image can be used as reference for measuring true ground distances.

Individual images may thus be processed using photogrammetry techniques, to rectify the images for distortions and inaccuracies in the acquired images, and/or to combine individual images (which may be partially overlapping) into larger mosaics. For example, the images may be adjusted to correct for terrain (e.g., topographic relief), platform (e.g., camera tilt), and sensor (e.g., lens distortion) induced distortions from remote sensing imagery.

The photogrammetric techniques used to rectify aerial images may correct for variations in scale, resolution, and coverage, and enable rectification, georeferencing, and mosaicking of remote imagery, as follows:
Scale is the ratio of a distance found on a representation, to the actual distance between the two objects. When imaging from an aircraft, scale will change with distance from an object. The higher the camera flies, the smaller an object will appear, and vice versa.
Resolution is a measure of how much area is represented by an image data unit (e.g., one pixel) in an imaging device. As the distance from an object increases, the camera is able to see more area per image data unit. This means that as a camera is flown higher, the resolution decreases.
Coverage area is the total ground area represented by a single image, which depends on the flight height and image device type and adjustment.
Image rectification is the process of flattening tilted images so that their normal vector is parallel to the normal vector of the ground plane they represent. When working with slow moving or light weight aerial platforms, their low speed and mass make them much more susceptible to the effects of wind and other atmospheric perturbations. Wind gusts and thermals among other things can cause an aircraft to move unexpectedly and even erratically. The motion of an aircraft can include pitch, roll and yaw, which directly affect how the camera is tilted in relation to the ground below. Rectification involves rotation of the image coordinate system x, y, z with respect to a reference coordinate system.
Mosaic images consist of multiple individual images made into a larger image. This is done by aligning two images based upon shared control points that appear in both images. These points can then be aligned based upon the plane created by the points. The best quality mosaics are usually generated from previously rectified images.

The image data obtained using remote-sensing may also be processed to obtain 3D models of the AOI. To construct the 3D models, photogrammetry requires at least two overlapping images of the same scene and/or object(s), captured from different points of view. These kind of techniques can be used for extracting three-dimensional digital surface or terrain models and/or orthophotos. UAV low-altitude data acquisition enables the construction of 3D models with a much higher spatial resolution compared to other remote sensing technologies (such as satellites). However, the collection of many images is required to have information for the entire field under study. Thus, in most cases, it is necessary to collect many overlapping images to construct digital elevation models (DEMs) of the crops and/or create orthophotos (also referred to as orthomosaics). For example, in the context of a tree farm where trees have an average height of, e.g., 4 m, the required overlap may be approx. 50% in the lateral and longitudinal dimensions between adjacent images taken at a >100 m altitude. However, low altitude imaging, taken at, e.g., a 60 m altitude, may require a much larger overlap between images of, e.g., 85%, or more. The 3D models and the orthophotos include information about the 3D characteristics of the crops based on the structure of the vegetation (e.g., the vegetation height, the canopy, the density, etc.).

Accordingly, The remote-sensing image data may be processed to construct 3D DEMs, which can provide information about the altitude of the earth surface, the natural and artificial objects/structures on the surface, the density of the crops and their physical dimensions and properties. There are two main types of DEMs:
Digital Terrain Models (DTM) represent the altitude of the surface of the terrain, without taking into account either artificial or natural objects that exist in the field. DTMs only present the elevation of the bare Earth.
Digital Surface Models (DSM) represent the altitude of the surface that is first encountered by the remote sensing system (i.e., when the aerial image captures the top of a building, tree, vegetation, etc.). Hence, the elevation model generated includes the elevation of the bare surface along with artificial and natural objects that may exist in the field, such as man-made structures, plants, vegetation, etc.

Image data obtained using remote sensing must also be geolocated or georeferenced to a reference system of ground coordinates. The output of this geolocating or georeferencing process is a model wherein the coordinates (x, y) of each pixel or point are mapped to a real-world reference coordinate system. Georeferencing is the process of aligning the image to an earth-centered coordinate system. In the context of aerial images, this is the alignment of a rectified image to an earth-based coordinate system, for example latitude and longitude.

Commonly, image georeferencing has relied on aerial triangulation based on the presence of ground control points (GCP) in the AOI. GCPs are typically man-made markers (e.g., having a checkerboard pattern), established on the ground in advance of the acquisition of the imagery. The GCPs can be precisely recognized in an image by virtue of their distinctive appearance, and used as anchor point to accurately align and register large areas. However, as noted, the need to establish and distribute multiple GCPs through a large area in advance, may require a costly and labor-intensive ground-operation, especially in the case of large-scale commercial farming.

Alternatively, georeferencing an image may rely on identifying existing feature points in the image data, which may be difficult for small-scale images within a crop field with few distinguishing features that may be used for georeferencing.

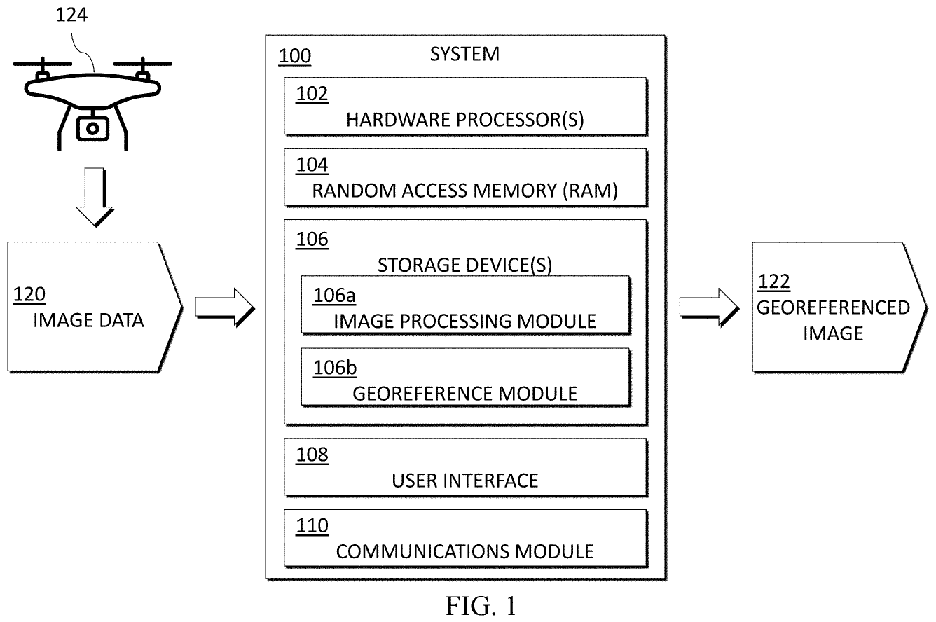

Reference is now made to FIG. 1, which is a schematic illustration of an exemplary system 100, for accurate georeferencing and geo-rectification of remotely-sensed image data (e.g., aerial images) of an area-of-interest (AOI), according to some embodiments of the present invention. In some embodiments, exemplary system 100 provides for accurate georeferencing and geo-rectification of remotely-sensed image data (e.g., aerial images) of an area-of-interest (AOI), in the absence of pre-established physical GCPs within the AOI.

System 100 may include one or more hardware processor(s) 102, and one or more storage devices comprising, e.g., a random-access memory (RAM) 104 and non-transitory computer-readable storage device(s) 106.

System 100 may store in a non-volatile memory thereof, such as storage device 106, software instructions or components configured to operate a processing unit (also “hardware processor,” “CPU,” or simply “processor), such as hardware processor 102. In some embodiments, the software components may include an operating system, including various software components and/or drivers for controlling and managing general system tasks (e.g., memory management, storage device control, power management, etc.) and facilitating communication between various hardware and software components. The program instructions may include one or more software modules, such as image processing module 106a and georeference module 106b. The software components may include an operating system having various software components and/or drivers for controlling and managing general system tasks (e.g., memory management, storage device control, power management, etc.), and facilitating communication between various hardware and software components.

The various components of system 100 may be implemented in hardware, software or a combination of both hardware and software. System 100 as described herein is only an exemplary embodiment of the present invention, and in practice may have more or fewer components than shown, may combine two or more of the components, or a may have a different configuration or arrangement of the components. In some embodiments, pats or all of system 100 may be stationary, mounted on board a moving vehicle, and/or airborne.

In some embodiments, image processing module 106a may include any one or more algorithms configured to perform any necessary and desired image processing tasks with respect to images captured by remote imaging platform 124, or by any other interior and/or external device, using any suitable image processing methods and technique.

In some embodiments, the image processing module 106a may be configured to receive as input image(s) 120, acquired, e.g., by remote imaging platform 124, sand apply any one or more image processing and/or computer vision algorithms or techniques. In some embodiments, image processing module 106a may be configured to perform any one or more of geo-rectification, ortho-rectification, georeferencing, and/or to construct orthomosaics from imagery, including remote sensing imagery. In some embodiments, image processing module 106a may be configured to perform one or more of object detection, object recognition, object tracking, and/or object segmentation based on one or more image processing techniques.

For example, in some embodiments, image processing module 106a may be configured to stitch together a series or sequence of overlapping individual images into a mosaic image. In some embodiments, the mosaicking process takes into account, e.g., the exterior position and orientation parameters of the UAV (e.g., roll, pitch and yaw angles) of every overlapped image. In some embodiments, image processing module 106a may be configured to perform one or more desired image modifications, transformations, filtering, enhancing, and/or any other manipulations with respect to received image data. As used herein, terms ‘image,’ ‘image data,’ and/or ‘digital image’ refer to any digital data capable of producing a visual representation, including digital images and digital video. Such data may comprise digital files in any suitable format, e.g., JPG, TIFF, BMP, PNG, RAW, or PDF files. Video data may refer to a digital sequence of images comprising comprise digital files in any suitable format, e.g., FLV, GIF, MOV, QT, AVI, WMV, MP4, MPG, MPEG, or M4V. Although much of the disclosure herein focuses on digital images, the present technique may be equally applied with regard to any type of digital visual media. For instance, in addition to digital images, the present technique may also apply with respect to multiple images/frames in a digital video. Depending on the embodiment, the image processing module 106a can also transmit and/or route image data through various processing functions, or to an output circuit that sends received and/or processed image data for further processing by one or more other modules of system 100; for presentation, e.g., on a display; to a recording system; across a network; or to any other logical destination. The image processing module 106a may apply any image processing algorithms alone or in combination. Image processing module 106a may also facilitate logging or recording operations with respect to any image data scan. In some embodiments, storage device 106 (which may include one or more computer readable storage mediums) may be used for storing, retrieving, comparing, and/or annotating captured images. Imaged may be stored on storage device 106 based on one or more attributes, or tags, such as a time stamp, a user-entered label, or the result of an applied image processing method indicating the association of the images, to name a few.

In some embodiments, georeference module 106b may be configured to receive one or images, e.g., an orthomosaic and/or a similar image from image processing module 106a, and to output a geolocated or georeferenced image 122 wherein each pixel and/or point is associated with a reference system of ground coordinates. In some embodiments, georeference module 106b may be configured to apply any suitable photogrammetry, orthro-rectification, aero-triangulation, and/or any similar technique involving the transformation of image co-ordinates to ground reference co-ordinates system.

In some embodiments, a user interface 108 may include, e.g., a display, an input device (e.g., keyboard, pointing device, touch-sensitive display), and/or an audio device (speaker).

In some embodiments, communications module 110 may connect system 100 to a network, such as the Internet, a local area network, a wide area network and/or a wireless network. Communications module 110 facilitates communications with other external information sources and/or devices, e.g., external imaging devices, over one or more external ports, and also includes various software components for handling data received by system 100. In some embodiments, communications module 110 may connect system 100 to a remote sensing platform, such as remote imaging platform 124, to receive image data such as input image(s) 120, and/or to provide operations instructions and/or any other type of data or information to remote imaging platform 124.

In some embodiments, remote imaging platform 124 may include one or more imaging devices, which may input one or more data streams and/or multiple images to enable identification of at least one object. In some embodiments, remote imaging platform 124 is configured to acquire images in one or more of the following imaging modalities: RGB, video, infrared, multi-spectral, and hyperspectral. In other embodiments, remote imaging platform 124 may include an interface to an external imaging device, e.g., which may input one or more data streams and/or multiple images to system 100 via remote imaging platform 124.

In some embodiments, remote imaging platform 124 may comprise any one or more of the following:
Visible light sensors (RGB),
multispectral imaging sensors,
hyperspectral imaging sensors, and/or
thermal infrared sensors.

In some embodiments, system 100 and/or remote imaging platform 124 may each further comprise a GPS module which may include a Global Navigation Satellite System, e.g., which may include a GPS, a GLObal NAvigation Satellite System (GLONASS), a Galileo satellite navigation system, and/or any other satellite navigation system configured to determine positioning information based on satellite signals. In some embodiments, GPS module may include an interface to receive positioning information from a control unit and/or from any other external system.

System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. System 100 may include any additional component enabling it to function as an operable computer system, such as a motherboard, data busses, power supply, a network interface card, etc. (not shown). Moreover, components of system 100 may be co-located or distributed, or the system may be configured to run as one or more cloud computing “instances,” “containers,” “virtual machines,” or other types of encapsulated software applications, as known in the art.

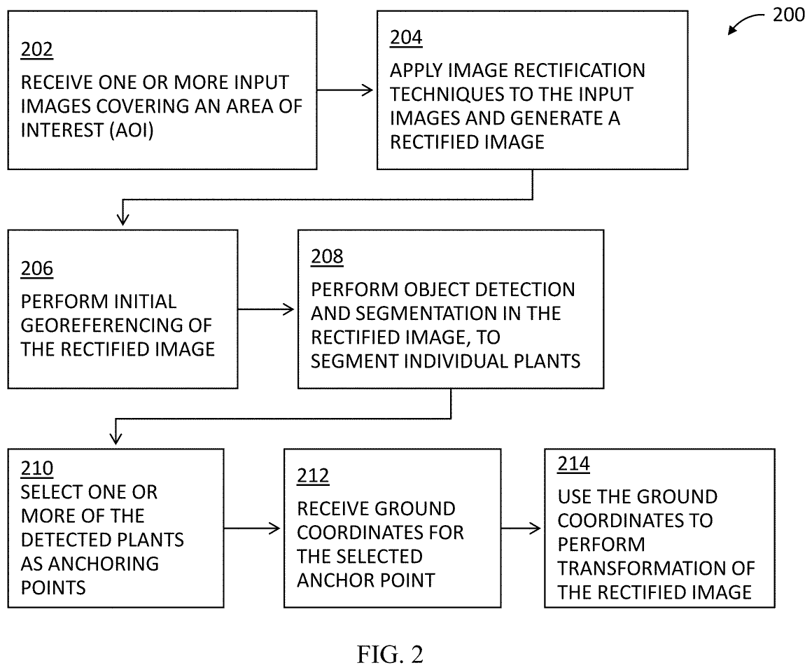

The instructions of image processing module 106a and/or georeference module 106b are now discussed with continued reference to FIG. 1 and with reference to the flowchart of FIG. 2, which illustrates the functional steps in a method 200 for accurate georeferencing and geo-rectification of remotely-sensed image data (e.g., aerial images) of an area-of-interest (AOI), according to some embodiments of the present invention. The various steps of method 200 may either be performed in the order they are presented or in a different order (or even in parallel), as long as the order allows for a necessary input to a certain step to be obtained from an output of an earlier step. In addition, the steps of method 200 are performed automatically (e.g., by system 100 of FIG. 1), unless specifically stated otherwise.

Method 200 begins in step 202, wherein system 100 receives input image(s) 120 representing one or more images, e.g., a series or sequence of images, which may be at least partially overlapping. In some embodiments, the received image data represents one or more images covering an area-of-interest (AOI). In some embodiments, the image data comprises a series of overlapping frames of aerial images which provide coverage of the AOI.

In some embodiments, the image data comprises one or more features that are geolocated or georeferenced to a coordinate system, such as a county GIS grid; World Geodetic System (WGS)-84; a latitude, longitude, and/or elevation values; and the like. In some embodiments, these features are obtained using, e.g., GPS and/or inertial measurement unit (IMU) measurements recorded by remote imaging platform 124 during the image data acquisition session.

In some embodiments, the AOI is associated with the growing of crops, e.g., a plot, an orchard, a grove, a vineyard, a field, and the like. In some embodiments, the crops within the AOI are cultivated plants, e.g., trees, vines, shrubs, and/or other types of plants. In some embodiments, the AOI is a cultivated agricultural area comprising, e.g., one or more defined agricultural plots, wherein each plot comprises a plurality of rows of crops in a generally known structured pattern.

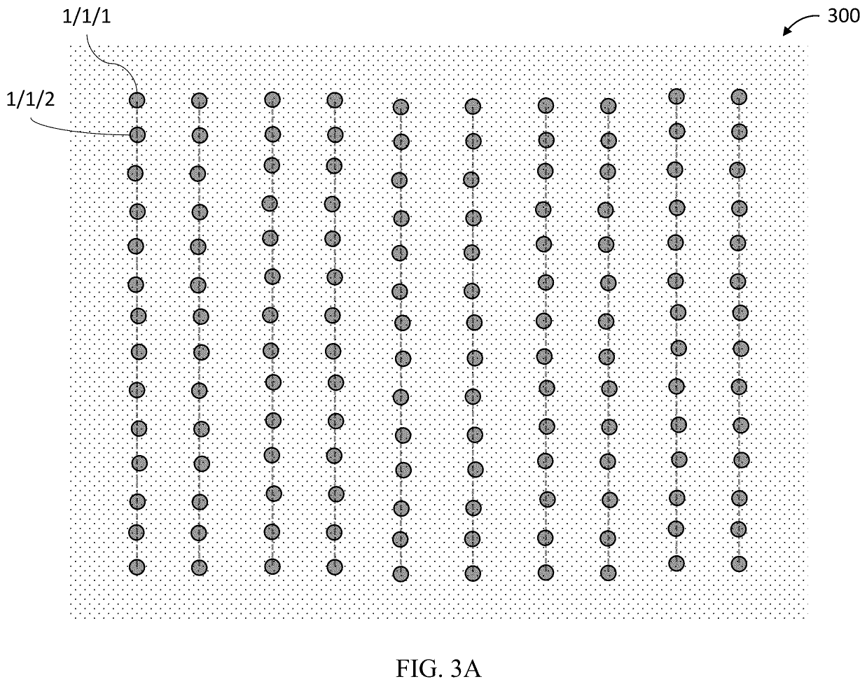

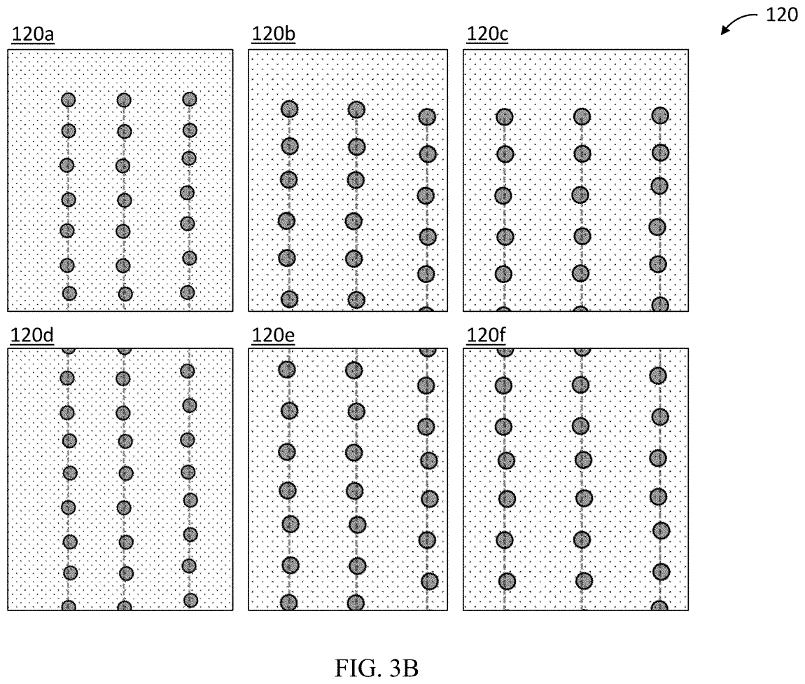

FIG. 3A shows an image of an AOI 300 comprising a plurality of rows of crops in a generally repeating pattern. AOI 300 may comprise any type of cultivated plants, e.g., trees, vines, shrubs, and/or other types of plants, represented as circles in FIG. 3. As can be seen, plant 1/1/1 is located at an outside corner of plot 1, e.g., line 1 of row 1, and thus may receive unique identification code 1/1/1.

FIG. 3B shows exemplary input image(s) 120 covering AOI 300 shown in FIG. 3A, comprising a series of images 120a-120f which may be at least partially overlapping

In some embodiments, the image data may be received from a remote-sensing source, e.g., a UAV image acquisition or any similar platform, such as remote imaging platform 124 shown in FIG. 1. In some embodiments, the image data represents low-altitude imagery, e.g., acquired at a height of, e.g., between 15-80 m, e.g., 60 m, above ground. In some embodiments, the one or more images are high-altitude/narrow FOV acquired at a height of, e.g., between 100-350 m, e.g., 124 m, above ground. In some embodiments, remote imaging platform 124 may be configured to execute a flight plan for the purpose of image data acquisition. In some embodiments, the flight plan may be configured to acquire image data with respect to all or part of AOI 300. In some embodiments, the flight plan path comprises a set of rectilinear segments approximating the land height contour lines, wherein the UAV moves one segment to the next by way of short transverse movements.

In some embodiments, in step 204, the instructions of image processing module 106a may cause system 100 to process the received series or sequence of input image(s) 120, by applying photogrammetry techniques to rectify any geometric distortion in the input image(s) 120.

For example, the instructions of image processing module 106a may cause system 100 to correct for variations in scale, resolution, and coverage among the input image(s) 120, and enable rectification, georeferencing, and mosaicking of input image(s) 120. In some embodiments, the rectified image(s) 120 have uniform scale, resolution, coverage, and correctly corresponds to the topology of AOI 300.

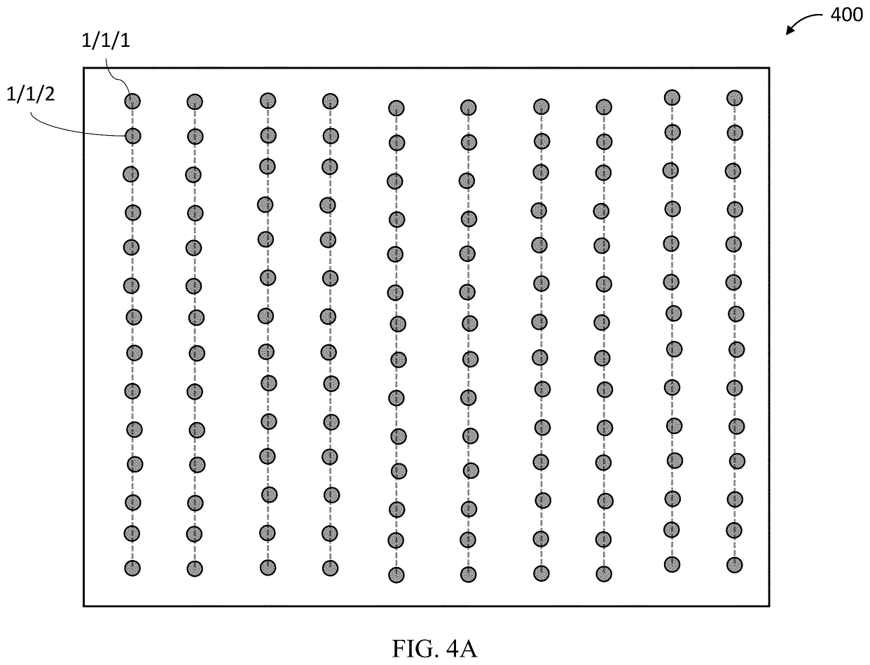

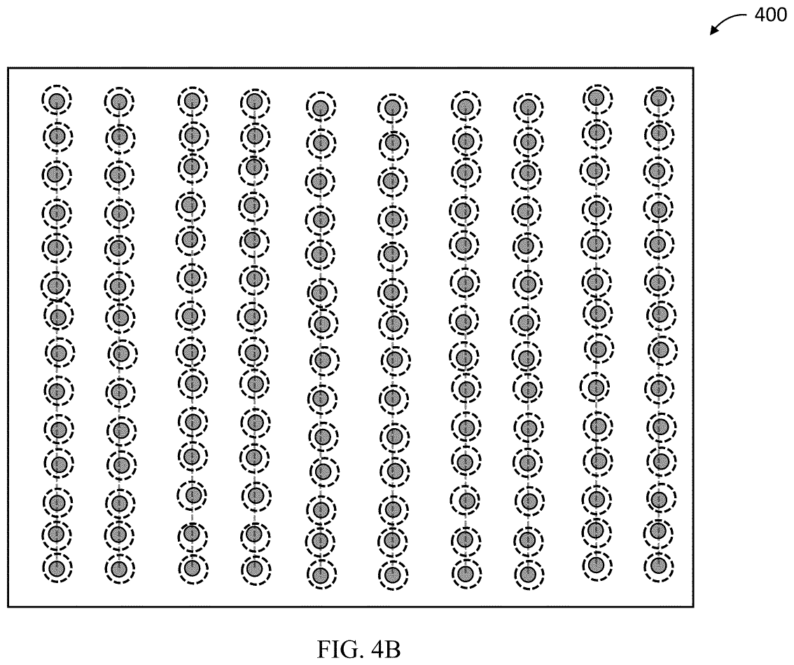

In some embodiments, the instructions of image processing module 106a may cause system 100 to produce a mosaic image consisting of multiple individual input images 120 (such as exemplary images 120a-120f shown in FIG. 3B). FIG. 4A shows a rectified image 400 (which may be a mosaic image) generated by rectifying one or more individual input image(s) 120 of AOI 300, and/or stitching together the one or more individual input image(s) 120. Rectified image 400 may be generated by merging and/or stitching the individual input images 120 to generate a single mosaicked rectified image 400 representing the AOI.

The rectification and mosaicking steps may be performed in any desired order. For example, individual input image(s) 120 may first be rectified and then mosaicked in image 400. Alternatively, individual input image(s) 120 may first be mosaicked and then the resulting image 400 may be rectified using the photogrammetry techniques discussed above.

In some embodiments, the instructions of image processing module 106a may further cause system 100 to construct one or more 3D digital elevation models (DEM) of AOI 300 from the input image(s) 120. In some embodiments, the constructed DEM provides information about the altitude of the earth surface, the natural and artificial objects/structures on the surface, the density of the crops and their physical dimensions and properties. In some embodiments, the constructed DEM is a digital terrain model (DTM), representing the altitude of the surface of the terrain, without taking into account either artificial or natural objects that exist in the field. In some embodiments, the constructed DEM is a digital surface model (DSM), representing the altitude of the surface that is first encountered by the remote sensing system (i.e., when the aerial image captures the top of a building, tree, vegetation, etc.), including the elevation of the bare surface along with artificial and natural objects that may exist in the field, such as man-made structures, plants, vegetation, etc.

In some embodiments, image processing module 106a may employ one or more photogrammetric techniques to obtain a 3D model of the AOI, represented as, e.g., a digital terrain model (DTM), a digital surface model (DSM), and/or a point cloud map. In some embodiments, the 3D model comprises data with respect to each plant comprising at least one of:
Plant height,
plant width,
plant volume,
plant mass,
stem and/or trunk diameter,
plant leaf density, and/or
plant leaf color.

In some embodiments, each point in the 3D model may be associated with reference map coordinates, e.g., a cartographic coordinate system in which the geolocated or georeferenced image will be expressed. A world coordinate system denotes a three-dimensional, homogeneous, isotropic Cartesian coordinate system, e.g., the World Geodesic System 1984 (WGS84). In some embodiments, the point cloud may comprise, with respect to each point, its relative height with respect to the local terrain surface

In some embodiments, in step 206, the instructions of georeference module 106b may cause system 100 to perform initial georeferencing of the geo-locate the rectified image 400 generated in step 204. In some embodiments, the geolocated or georeferenced image may represent a uniform relationship to real-world measurements, wherein coordinates (x, y) of each pixel and/or point in the image are associated with coordinates within a reference world coordinate system. In some embodiments, geolocating or georeferencing is performed based on, e.g., location measurements associated with the image, such as, e.g., GPS coordinates reading and/or inertial measurement unit (IMU) coordinates measurements recorded by remote imaging platform 124 during the image data acquisition session.

For example, remote imaging platform 124 may be equipped with control systems which could record the time, position, and attitude of the camera exposure during image acquisition. Thus, initial georeference may be achieved by synchronizing the images to positioning and orientation system data.

In some embodiments, in step 208, the instructions of image processing module 106a may cause system 100 to process image data received in step 200, to reconstruct a scene of the AOI from the multiple overlapping images acquired over the AOI

Steps 202-206 detailed above disclose individual steps within a photogrammetry process as part of method 200, and may be performed in the order they are presented or in a different order, or even in parallel, as long as the order allows for a necessary input to a certain step to be obtained from an output of an earlier step.

In some embodiments, in step 208, the instructions of image processing module 106a may cause system, 100 to process the rectified image 400 generated in step 202-206, to perform any of object detection, classification, and/or segmentation of individual plants in the image data. For example, in some embodiments, the rectified image 400 may be processed to segment individual plants present in AOI 300, i.e., to isolate and/or delineate individual plants in AOI 300. For example, in the case of an AOI 300 that is a grove comprising trees, the segmentation may involve segmenting and/or delineating individual tree crowns or canopies in the AOI 300. In some embodiments, any suitable one or more methods or techniques may be employed, e.g., manual segmentation, thresholding-based methods, machine learning-based method, deep learning-based methods, and the like.

FIG. 4A shows an exemplary rectified image 400 of AOI 300 comprising a plurality of rows of crops in a generally structured pattern. Rectified image 400 may be an ortho-rectified mosaic image generated through the processes and techniques described with reference to steps 200-206 above. As an example, the process of step 208 is able to detect and segment in rectified image 400, e.g., individual plants comprising a plurality of rows in an agricultural plot.

FIG. 4B shows rectified image 400 after the process of plant detection and segmentation. As can be seen, individual plants are delineated with dashed circles.

In some embodiments, in steps 210-214, the instructions of georeferencing module 106b may cause system, 100 to perform a process which refines the initial georeferencing of rectified image 400 performed in step 206, to enable an accurate registration and alignment of rectified image 400 to AOI 300.

By way of explanation, rectified image 400 generated in steps 200-208 may still represent significant geometric distortions, such that objects in rectified image 400 (i.e., plants) may not be accurately geolocated or georeferenced. Thus, a plant in rectified image 400 may be represented as having a location associated with specific coordinates, however, such coordinates may still deviate from the actual location of its corresponding ‘ground truth’ location of the plant in AOI 300, as determined, e.g., using direct ground-based measurements. These distortions and deviations may limit the ability of growers to devise and implement plant- and/or site-specific farming operations, e.g., fertilization, pruning, spraying, and the like.

Accordingly, in some embodiments, steps 210-214 provide for establishing an alignment which may enable creating a correspondence between each plant in the AOI and its image representation. Thus, each individual plant detected and segmented in the image in step 208, may be associated with a particular plant on the ground, and assigned a unique identification code. In some embodiments, in the case of plots arranged in a structured pattern, such as rows, a plant identification code may indicate a plot/row/line number combination, e.g., 1/21/48 (plot 1, row 21, line 48). However, any other suitable identification code combination may be employed. As can be seen in FIG. 3A, plant 1/1/1 is located at an outside corner of plot 1, e.g., line 1 of row 1, and thus may receive unique identification code 1/1/1.

Typically, such alignment process relies on pre-established GCPs within the AOI. However, as noted above, the present technique does not require the use of pre-established GCPs, which is a time consuming and costly task.

Accordingly, in some embodiments, in step 210, the instructions of georeference module 106b may cause system 100 to select at least one anchor point in the image data, e.g., one of the plant detected and segmented in step 208, and associate the selected anchor points with corresponding ground anchor points on the ground. Thus, for example, the present technique provides for selecting a first anchor point in the image data, e.g., an individual plant representing a high likelihood of establishing an identification correspondence with its ‘ground-truth’ plant, for example, because of its easily-identified location within the AOI. For example, such an anchor point may be a plant located at a corner of a plot. For example, with reference back to FIG. 3A, plant 1/1/1 may be relatively easy to identify in rectified image 400 with a high degree of confidence, and may thus be selected as at least a first anchor point.

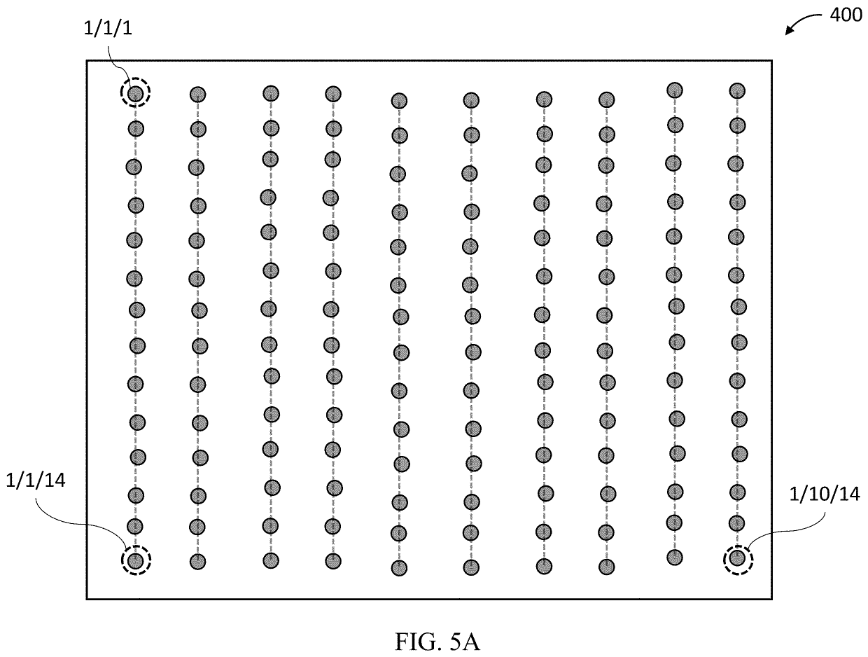

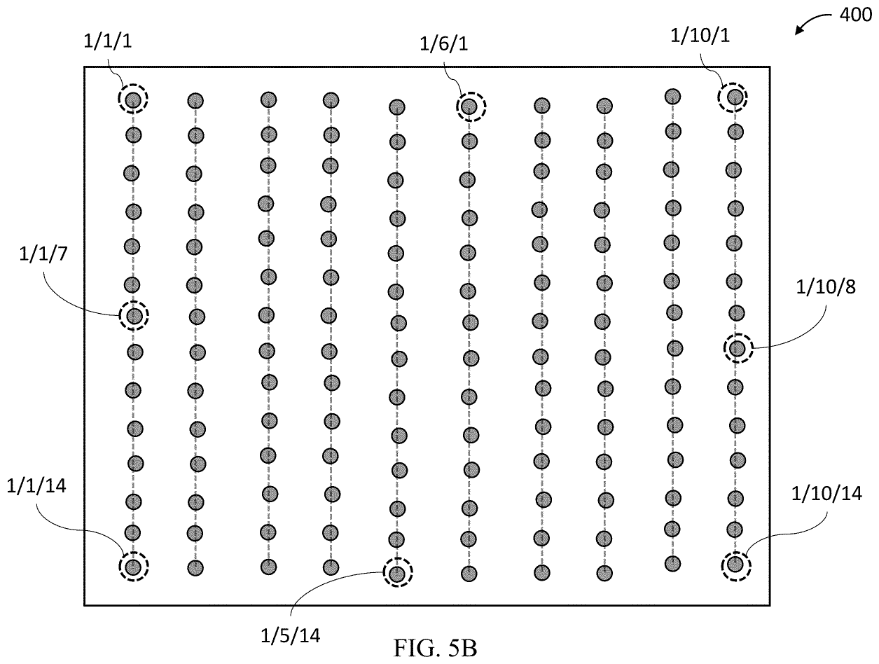

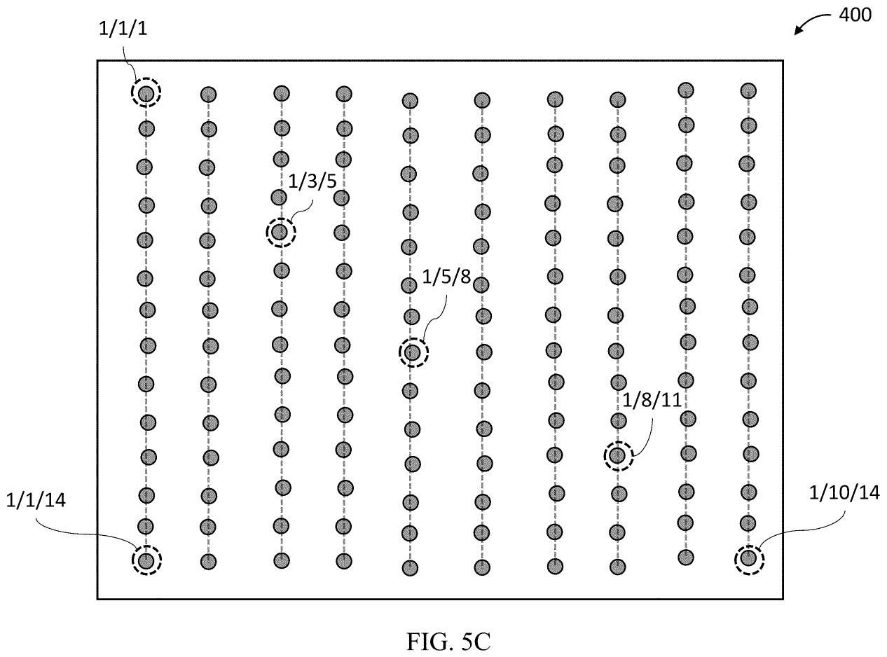

In some embodiments, the present technique provides for selecting two or more anchor points. For example, as can be seen in FIG. 5A, three corner plants may be selected in plot 1 as anchor points, e.g., plants 1/1/1, 1/1/14, and 1/10/14. In other examples, any number of corner plants may be selected, e.g., 2, 3, 4 corner plants.

In some embodiments, the present technique provides for selecting two or more outer row or outer edge plants within a plot, e.g., some or all of the outer edge plants delineating the plot, as anchor points. As can be seen in FIG. 5B, a plurality of outer edge plants may be selected, e.g., plants 1/1/1, 1/1/7, 1/1/14, 1/5/14, 1/6/1, 1/10/1, 1/10/8, and/or 1/10/14.

In some embodiments, the present technique provides for selecting two or more outer row or outer edge plants within a plot as anchor points, in combination with interior plants within the plot. As can be seen in FIG. 5C, a plurality of outer edge plants may be selected, e.g., plants 1/1/1, 1/1/14, and/or 1/10/14, in combination with interior plants 1/3/5, 1/5/8 and/or 1/8/11.

In some embodiments, the number and/or distribution and/or location of the selected anchor points may be determined based on the size and scale of the AOI being mapped, the topographic complexity of the scene, the quality and accuracy of the remote sensing platform used to acquire that image data, and a desired degree of accuracy of the final alignment. In some embodiments, generally, a larger number of anchor points distributed through the AOI may result in greater accuracy of the final result.

In some embodiments, in step 212, the present technique provides for receiving, e.g., by georeference module 106b, ‘ground-truth’ location information with respect to one or more of the selected anchor points. The ground-truth location information may provide exact ground coordinates of a plant corresponding to each selected anchor point in rectified image 400. In some embodiments, such ground coordinates may be obtained using ground-based methods.

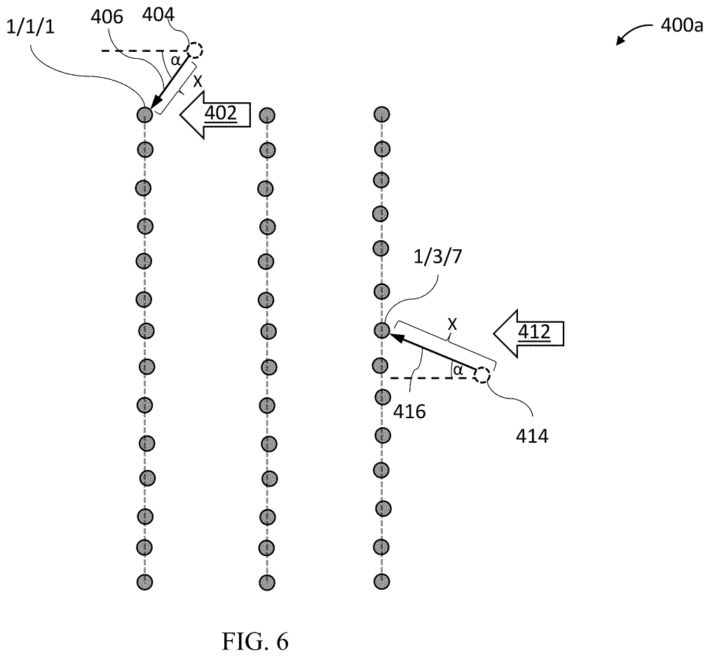

FIG. 6 illustrates a region 400a of rectified image 400 comprising three rows of plants. Plant 1/1/1 may be selected as at least a first anchor point in rectified image 400. In step 212, a ground-based measurement may be taken to establish the ground-truth coordinates of plant 1/1/1. The ground-based measurement may be obtained, for example, from vantage point 402, that is, from a midpoint between rows 1 and 2 within the plot. The ground-based measurement may be obtained using any suitable method, e.g., using any imaging and/or ranging and/or scanning technique in combination with precise GPS measurements, to establish the true coordinates of plant 1/1/1 in relation to vantage point 402. In some embodiments, vantage point 402 may be observed from, e.g., a ground transport platform equipped with data acquisition component, comprising, e.g., imaging devices, a 3D laser scanner, and a GPS receiver.

The initial georeferenced coordinates assigned to plant 1/1/1 within rectified image 400 in step 206 may then be reconciled with the ground-truth coordinates of plant 1/1/1. In some embodiments, because of geometric distortions within rectified image 400, the initial geolocated or georeferenced assigned coordinates of plant 1/1/1 within rectified image 400 may deviate from its ground-truth location, represented by numeral reference 404. In the example of FIG. 6, the initial coordinates assigned to plant 1/1/1 in rectified image 400 in step 206 deviate from its actual ground-truth location at reference 404. In some embodiments, the reconciliation process may produce an offset vector 406, indicating an extent X and direction a of a deviation between the assigned geolocated or georeferenced location of plant 1/1/1 in rectified image 400, and its ground-truth location at reference 404.

Similarly, the initial georeferenced coordinates assigned to plant 1/3/7 in step 206 may then be reconciled with the ground-truth coordinates of plant 1/3/7 (taken, e.g., the from vantage point 412). Again, because of geometric distortions within rectified image 400, the initial geolocated or georeferenced coordinates of plant 1/3/7 within rectified image 400 (as assigned in step 206) may deviate from its ground-truth location, represented by numeral reference 414. In this case, the reconciliation process may produce an offset vector 416, indicating an extent X and direction a of a deviation between the geolocated or georeferenced location of plant 1/3/7 in rectified image 400, and its ground-truth location at reference 414. deviation 416 may be different, i.e., have different extent and/or direction, from offset vector 406.

In some embodiments, a similar process may be undertaken with respect to any number of anchor points in rectified image 400, e.g., plants 1/1/1, 1/1/14, and 1/10/14 in FIG. 5A; plants 1/1/1, 1/1/7, 1/1/14, 1/5/14, 1/6/1, 1/10/1, 1/10/8, and/or 1/10/14 in FIG. 5B; and/or plants 1/1/1, 1/1/14, and/or 1/10/14, in combination with interior plants 1/3/5, 1/5/8 and/or 1/8/11, in FIG. 5C.

Accordingly, in some embodiments, the instructions of georeference module 106b may cause system 100 to perform reconciliation of at least some of the anchor points selected in step 210, with the ground-truth coordinates obtained in step 212. In some embodiments, the reconciliation process may result in an offset vector associated with each anchor point.

In some embodiments, in step 214, the instructions of georeference module 106b may cause system 100 to calculate a multi-parametric transformation matrix which aligns rectified image 400 to the ground coordinates of AOI 300, such that each pixel and/or data point in rectified image 400 is associated with a ground location in the reference system of coordinates.

The instructions of georeference module 106b may then cause system to align rectified image 400 to the ground-truth coordinates of AOI 300, based on the transformation matrix. In some embodiments, step 214 may thus comprise applying a transformation to rectified image 400 to align rectified image 400 with the reference coordinate system of AOI 300.

Finally, system 100 may output be configured to output rectified and georeferenced image 122 of AOI 300 in which each data point (pixel) is accurately associated with a geographic location. In some embodiments, georeferenced image 122 may comprise a 3D model of AOI 300, represented as, e.g., a digital terrain model (DTM), a digital surface model (DSM), and/or a point cloud map.

In some embodiments, system 100 may be configured to use a 3D model of AOI 300, as constructed by method 200, to generate and implement a plant- and/or site-specific farming plan, comprising one or more operations, e.g., fertilization, pruning, spraying, and the like.

For example, a plant- or site-specific plan may enable to apply variable treatment to each plant and/or site, to achieve better treatment results and/or reduction in resource waste. Such plan may rely on one or more physical and/or other attributes of each individual plants, in combination with its known precise ground location, to modify a treatment plan to the particular plant. Such physical attributes may include, but are not limited to, height, width, mass, shape, volume, leaf density, trunk diameter, leaf color, fruit size, and the like.

In one particular example, a spraying operation within a plot of plants typically must be applied to the plants along their height dimension. Thus, when plant height is variable within the plot, the spray area typically is adjusted to account for the tallest plant. This often results in wasted resources, as shorter and taller plants are sprayed using the same height setting of the sprayer.

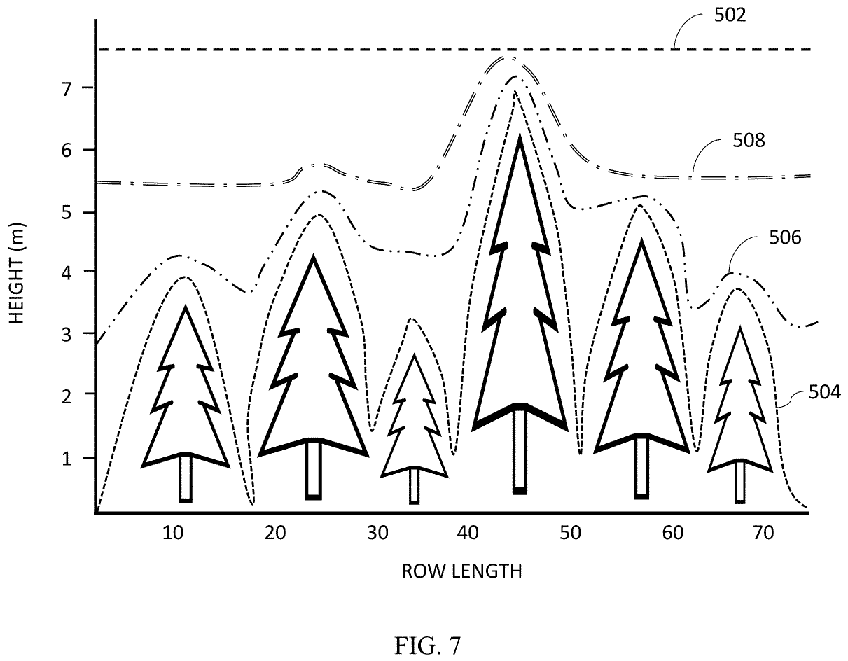

FIG. 7 shows a height adjustment parameter of a sprayer under various spraying plans for a row of trees of varying height. Absent plant-specific height data, the spraying plan must be applied such that a sprayer height parameter is set at the 99th percentile of all plant, represented by dashed line 502. As is readily understood, such ‘one size fits all’ plan is by necessity wasteful.

In contrast, when plant height, width, volume, and/or similar physical attributes are known (in combination with exact plant location), a spraying plan may be modified and adjusted to become plant- or site-specific. For example, various plans may be formulated with varying degrees of accuracy resolution, wherein increased accuracy represents a decrease in resource waste. For example, line 504 represents a spraying plan where a resolution window is set at 50 cm window, meaning that a height parameter of the sprayer may be adjusted every 50 cm of movement along a row of plants. Such resolution may offer a relatively high degree of material savings, e.g., 35-45%. Lines 506 and 508 represent spraying plans where a resolution window is set a 200 cm and 600 cm window, respectively. Such resolution may offer a relatively smaller degree of material savings, e.g., 30% and 25%, respectively.

The present invention may be a computer system, a computer-implemented method, and/or a computer program product. The computer program product may include a computer readable storage medium (or media) having computer readable program instructions thereon for causing a hardware processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
at least one hardware processor; and
a non-transitory computer-readable storage medium having stored thereon program instructions, the program instructions executable by the at least one hardware processor to:
receive an image of an agricultural area-of-interest (AOI), wherein the AOI comprises a plurality of rows of plants ordered in a known pattern, and wherein the image is obtained during an image acquisition session by a remote-sensing platform,
perform an initial rectification with respect to the image, to correct geometric distortions in said image,
assign initial geographic coordinates within a reference coordinate system to each data point in said image, based, at least in part, on location data recorded by said remote-sensing platform during said image acquisition session,
perform object detection in said image, to detect at least some of said plants in said image,
select a specified subset of said detected plants,
calculate a transformation between said image and said reference coordinate system based on a comparison, with respect to each of said plants in said specified subset, between (i) said initial geographic coordinates assigned to said plant, and (ii) corresponding ground-truth geographic coordinates obtained with respect said plant, and
perform an alignment between said image and said reference coordinate system based, at least in part, on said calculated transformation.

2. The system of claim 1, wherein said calculating comprises determining, with respect to each of said plants in said specified subset, an offset vector representing an extent and direction of a location offset between (i) said geographic coordinates assigned to said plant, and (ii) ground-truth geographic coordinates obtained with respect to said plant.

3. The system of claim 2, wherein said calculating further comprises calculating a global transformation matrix, based, at least in part, on all of said calculated offset vectors.

4. The system of claim 1, wherein said remote-sensing platform comprises one of: an unmanned aerial vehicle (UAV), a manned aerial vehicle, a helicopter, an airplane, and a satellite.

5. The system of claim 1, wherein said image is a mosaicked image generated from a set of at least partially overlapping images of said AOI.

6. The system of claim 5, wherein said program instructions are further executable to generate a three-dimensional (3D) model of said AOI using said set of at least partially overlapping images.

7. The system of claim 1, wherein said specified subset of plants comprises one or more of the following categories: at least one plant located at an outside corner of said AOI, least one plant located at an outer row or an outer edge of said AOI, and at least one plant located within an interior of said AOI.

8. A computer-implemented method comprising:
receiving an image of an agricultural area-of-interest (AOI), wherein the AOI comprises a plurality of rows of plants ordered in a known pattern, and wherein the image is obtained during an image acquisition session by a remote-sensing platform;
performing an initial rectification with respect to the image, to correct geometric distortions in said image;
assigning initial geographic coordinates within a reference coordinate system to each data point in said image, based, at least in part, on location data recorded by said remote-sensing platform during said image acquisition session;
performing object detection in said image, to detect at least some of said plants in said image;
selecting a specified subset of said detected plants;
calculating a transformation between said image and said reference coordinate system based on a comparison, with respect to each of said plants in said specified subset, between (i) said initial geographic coordinates assigned to said plant, and (ii) corresponding ground-truth geographic coordinates obtained with respect said plant; and
performing an alignment between said image and said reference coordinate system based, at least in part, on said calculated transformation.

9. The computer-implemented method of claim 8, wherein said calculating comprises determining, with respect to each of said plants in said specified subset, an offset vector representing an extent and direction of a location offset between (i) said geographic coordinates assigned to said plant, and (ii) ground-truth geographic coordinates obtained with respect to said plant.

10. The computer-implemented method of claim 9, wherein said calculating further comprises calculating a global transformation matrix, based, at least in part, on all of said calculated offset vectors.

11. The computer-implemented method of claim 8, wherein said remote-sensing platform comprises one of: an unmanned aerial vehicle (UAV), a manned aerial vehicle, a helicopter, an airplane, and a satellite.

12. The computer-implemented method of claim 8, wherein said image is a mosaicked image generated from a set of at least partially overlapping images of said AOI.

13. The computer-implemented method of claim 12, further comprising generating a three-dimensional (3D) model of said AOI using said set of at least partially overlapping images.

14. The computer-implemented method of claim 8, wherein said specified subset of plants comprises one or more of the following categories: at least one plant located at an outside corner of said AOI, least one plant located at an outer row or an outer edge of said AOI, and at least one plant located within an interior of said AOI.

15. A computer program product comprising a non-transitory computer-readable storage medium having program instructions embodied therewith, the program instructions executable by at least one hardware processor to:
receive an image of an agricultural area-of-interest (AOI), wherein the AOI comprises a plurality of rows of plants ordered in a known pattern, and wherein the image is obtained during an image acquisition session by a remote-sensing platform;
perform an initial rectification with respect to the image, to correct geometric distortions in said image;
assign initial geographic coordinates within a reference coordinate system to each data point in said image, based, at least in part, on location data recorded by said remote-sensing platform during said image acquisition session;
perform object detection in said image, to detect at least some of said plants in said image;
select a specified subset of said detected plants;
calculate a transformation between said image and said reference coordinate system based on a comparison, with respect to each of said plants in said specified subset, between (i) said initial geographic coordinates assigned to said plant, and (ii) corresponding ground-truth geographic coordinates obtained with respect said plant; and
perform an alignment between said image and said reference coordinate system based, at least in part, on said calculated transformation.

16. The computer program product of claim 15, wherein said calculating comprises determining, with respect to each of said plants in said specified subset, an offset vector representing an extent and direction of a location offset between (i) said geographic coordinates assigned to said plant, and (ii) ground-truth geographic coordinates obtained with respect to said plant.

17. The computer program product of claim 16, wherein said calculating further comprises calculating a global transformation matrix, based, at least in part, on all of said calculated offset vectors.

18. The computer program product of claim 15, wherein said image is a mosaicked image generated from a set of at least partially overlapping images of said AOI.

19. The computer program product of claim 18, wherein said program instructions are further executable to generate a three-dimensional (3D) model of said AOI using said set of at least partially overlapping images.

20. The computer program product of claim 15, wherein said specified subset of plants comprises one or more of the following categories: at least one plant located at an outside corner of said AOI, least one plant located at an outer row or an outer edge of said AOI, and at least one plant located within an interior of said AOI.
